(19) United States
(12) Patent Application Publication
(10) Pub. No.: US 2017/0233601 A1
(43) Pub. Date: Aug. 17, 2017

(54) ANTI-FOG COATINGS AND METHODS

(71) Applicant: Honeywell International Inc., Morris Plains, NJ (US)

(72) Inventors: Marilyn Wang, Pudong New Area, Shanghai (CN); Alex Gu, Plymouth, MN (US); Xiaorong You, Shrewsbury, MA (US); Jon Nebo, Waltham, MA (US); Minling Liu, Shanghai, Shanghai (CN); Brian Keith Olmsted, Richfield, MN (US)

(21) Appl. No.: 15/519,293

(22) PCT Filed: Oct. 15, 2014
(86) PCT No.: PCT/CN2014/088634

§ 371 Date: Apr. 14, 2017

(51) Int. Cl. C09D 163/00; B05D 3/06

(52) U.S. Cl. CPC C09D 163/00; B05D 3/067; C08K 5/42

(57) ABSTRACT

An anti-fog coating and preparation thereof are provided. The anti-fog coating comprises a cationically polymerizable compound including at least one epoxy group, a radically polymerizable compound including at least one acrylate group, a non-ionic surfactant and an ionic surfactant.

### TECHNICAL FIELD

The present subject matter relates generally to anti-fog coating compositions, such as transparent polymeric materials, methods for forming coated transparent polymeric materials, and coated transparent polymeric materials. More particularly the present application relates to epoxy-acrylate hybrid coating compositions that impart long-lasting anti-fog performance for transparent polymeric materials, methods for forming coated transparent polymeric materials using such coating compositions, and coated transparent polymeric materials with long-lasting anti-fog performance.

### BACKGROUND

Transparent polymeric materials are used for a variety of products through which light is transmitted for viewing an image. The transparent polymeric material typically has a first surface and a second surface. One surface can be curved relative to the other to change the direction of light to the eye, such as in an ophthalmic lens of eyeglasses, or alternatively, the surfaces can be parallel, such as in a television screen or a face shield of a protective helmet. Common lens forming materials include CR-39 (diethyleneglycolbisallyl carbonate), bisphenol A polycarbonate (PC), and poly(methylmethacrylate)(PMMA). These lens forming materials are lighter and more shatter resistant than traditional glass and offer excellent transparency and low haze. Despite the above noted benefits, some serious drawbacks to transparent polymeric materials include their susceptibility to fogging, scratching, or abrasion.

Transparent polymeric materials become fogged when tiny water droplets condense on the surface and cause light to scatter, rendering the surface translucent. Fogging typically occurs when a cold surface suddenly comes in contact with warm, moist air. In some cases, fogging can be a dangerous condition, for example, when the fogged material is an ophthalmic lens affecting a user's vision. Additionally, transparent polymeric materials are much softer than glass and can be easily scratched under normal actions such as cleaning, wiping off dust, and normal handling while in use. Over time, scratches and abrasions on the surface can also obscure the user's vision.

Consequently, such transparent polymeric surfaces are often treated with one or more coatings to provide anti-fog performance, and scratch or abrasion resistance. Lens coatings can be applied in different ways, such as, for example, using a dip coating process or a spin coating process. Multiple coatings may also be necessary to obtain other properties such as a mirror coating, and stain and smudge resistance.

In this regard, much research has been devoted to providing coatings for transparent polymeric materials to improve their anti-fog performance, and scratch or abrasion resistance. State of the art anti-fog (AF) technologies typically include two approaches to maintain surface transparency after moisture condensation. One approach is to treat a surface by applying a completely hydrophilic coating to absorb all of the water molecules in the coating's interior; or alternatively, another approach is to embed hydrophilic surfactants within an otherwise hydrophobic coating to reduce the water contact angle and to spread condensed moisture from scattered and scattering droplets into a flat film (sheeting), thereby minimizing the transmission loss. Each of these approaches has its own limitations and shortcomings.

Most anti-fog coatings on the market include incorporating mobile surfactants into a coating matrix. When moisture condensation occurs, the surfactants will either migrate to or orient towards the top surface to reduce the water-solid interfacial tension and the contact angle. As the surfactants are not chemically bonded to the coating structure, the surfactants will be washed off the surface either by repeated use or cleaning, leading to a fade-away AF effect. Therefore, they are suitable for providing only a temporary, i.e., not durable, AF effect. As such, research has been conducted to put epoxy in AF coatings to reduce the diffusion speed and rate of surfactant from to coating. However, the introduction of epoxy into the AF coating mitigates the AF performance, as well as the coating curing behavior and cross-linking degree. In addition, the surface is prone to damage and staining. Moreover, the plasticizing effect of the surfactant on the coating surface often makes the coating more vulnerable to abrasion and contamination.

Chemistries and coating processes for these coatings range from thermally cured coatings to ultraviolet (UV) cured coatings. Unfortunately, many of these conventional coatings have several drawbacks. For example, current anti-fog coatings are generally not long-lasting and often lose effectiveness after only a few lens cleanings. Moreover, many of these coatings require the use of a solvent or a primer that is undesirably high in volatile organic compound (VOC) content. Furthermore, while thermally cured coatings may provide good scratch resistance, they also require long cure times and high energy consumption for solvent evaporation. Additionally, while UV cured coatings provide fast cure, energy savings, and high throughput production, their scratch resistance is generally poorer than with thermally cured coatings.

### SUMMARY

An anti-fog coating can include a cationically polymerizable compound, a radically polymerizable compound, a non-ionic surfactant, and an ionic surfactant. In an example, the cationically polymerizable compound includes at least one epoxy group. Further, the radically polymerizable compound can include at least one acrylate group.

A method for forming an anti-fog coated surface includes preparing an anti-fog coating. The anti-fog coating can include a cationically polymerizable compound, a radically polymerizable compound, a non-ionic surfactant, and an ionic surfactant. In an example, the cationically polymerizable compound includes at least one epoxy group. Further, the radically polymerizable compound can include at least one acrylate group. The cationically polymerizable compound and the radically polymerizable compound are polymerized to form the coated surface. In an example the method can include washing the coated surface, including contacting the anti-fog coated surface with water and drying the anti-fog coated surface.

### DETAILED DESCRIPTION

The following Detailed Description is merely exemplary in nature and is not intended to limit the subject matter or the application and uses of the same. Furthermore, there is no intention to be bound by any theory presented in the preceding background or the following detailed description.

In an embodiment, an improved coating system for transparent polymeric materials, such as ophthalmic lenses, provides improved characteristics in the form of anti-fog performance and scratch or abrasion resistance, while also providing improved manufacturability and rapid curing as compared to prior art coating systems. Generally, the coating system described herein is a composite coating that hybridizes both epoxy and acrylate coating materials into a single coating system that can have a reduced surfactant diffusion rate, as compared to previous approaches. In this manner, the coating system exhibits the mechanical properties imparted by epoxies creating a highly abrasion resistant coating while also including the advantageous properties of radiation cured coatings imparted by acrylates in the form of rapid processing and curing as well as a superior vehicle for retaining surfactants.

Embodiments herein provide coating compositions that impart long-lasting anti-fog performance for transparent polymeric materials, methods for forming coated transparent polymeric materials using such coating compositions, and coated transparent polymeric materials with long-lasting anti-fog performance. Moreover, coating compositions described herein can impart improved properties such as scratch and/or abrasion resistance, rapid curing, and/or relatively low solvent/VOC content, methods for forming coated transparent polymeric materials using such coating compositions, and coated transparent polymeric materials that include such coating compositions. Furthermore, other features and characteristics of the present subject matter will become apparent from the subsequent detailed description and the appended claims, taken in conjunction with this background.

Various optical terms are used to describe the transparent polymeric material, e.g., lens, ophthalmic lens, optical filter, and the like. To facilitate the understanding of the detailed description, some terms are initially defined as follows:

Lens: an ophthalmic lens that provides refractive correction or a lens that provides no refractive correction also known as a “plano lens”.

Visible light spectrum: energy emissions having a wavelength of between approximately 400 nm and 780 nm.

Blocking: a measure of the percentage of light that is either reflected by the surface or surface coatings or absorbed by the dye or plastic of the lens.

In an example, the coating includes a cationically polymerizable compound including at least one epoxy group, a radically polymerizable compound including at least one acrylate group, a non-ionic surfactant, and an ionic surfactant.

In an example, the coating is a suspension that includes organic polymeric constituents and, optionally, solvents. A polymeric constituent may be a monomer or a polymer in solvent. For example, the coating may include monomers that polymerize upon curing. Alternatively or in addition, the coating may include polymer material in a solvent. The particulate filler generally forms a dispersed phase within the coating.

The coating may include one or more reaction constituents or polymer constituents for the preparation of a polymer. A polymer constituent may include monomeric molecules, polymeric molecules or a combination thereof. The coating may further comprise components selected from the group consisting of solvents, plasticizers, chain transfer agents, catalysts, stabilizers, surfactants, curing agents, reaction mediators and agents for influencing the fluidity of the dispersion.

The polymer constituents can form thermoplastics or thermosets. By way of example, the polymer constituents may include monomers and resins for the formation of polyurethane, polyurea, polymerized epoxy, polyester, polyimide, polysiloxanes (silicones), polymerized alkyd, styrene-butadiene rubber, acrylonitrile-butadiene rubber, polybutadiene, or, in general, reactive resins for the production of thermoset polymers. Another example includes an acrylate or a methacrylate polymer constituent. The precursor polymer constituents are typically curable organic material (i.e., a polymer monomer or material capable of polymerizing or crosslinking upon exposure to heat or other sources of energy, such as electron beam, ultraviolet light, visible light, etc., or with time upon the addition of a chemical catalyst, moisture, or other agent which cause the polymer to cure or polymerize). A precursor polymer constituent example includes are active constituent for the formation of an amino polymer or an aminoplast polymer, such as alkylated urea-formaldehyde polymer, melamine-formaldehyde polymer, and alkylated benzoguanamine-formaldehyde polymer; acrylate polymer including acrylate and methacrylate polymer, alkyl acrylate, acrylated epoxy, acrylated urethane, acrylated polyester, acrylated polyether, vinyl ether, acrylated oil, or acrylated silicone; alkyd polymer such as urethane alkyd polymer; polyester polymer; reactive urethane polymer; phenolic polymer such as resole and novolac polymer; phenolic/latex polymer; epoxy polymer such as bisphenol epoxy polymer; isocyanate; isocyanurate; polysiloxane polymer including alkylalkoxysilane polymer; or reactive vinyl polymer. The coating of the coating formulation may include a monomer, an oligomer, a polymer, or a combination thereof. In a particular embodiment, the coating of the coating formulation includes monomers of at least two types of polymers that when cured may crosslink. For example, the coating may include epoxy constituents and acrylic constituents that when cured form an epoxy/acrylic polymer.

In an embodiment, the polymer reaction components include an ionically and cationically polymerizable precursors. For example, the coating may include at least one cationically curable component, e.g., at least one cyclic ether component, cyclic lactone component, cyclic acetal component, cyclic thioether component, spiroorthoester component, epoxy-functional component, or oxetane-functional component. Typically, the coating includes at least one component selected from the group consisting of epoxy-functional components and oxetane-functional components. The coating may include, relative to the total weight of the composite coating formulation, at least about 10 wt. % of cationically curable components, for example, at least about 20 wt. %, typically at least about 40 wt. %, or at least about 50 wt. %. Generally, the coating includes, relative to the total weight of the composite coating formulation, not greater than about 95 wt. % of cationically curable components, for example, not greater than about 90 wt. %, not greater than about 80 wt. %, or not greater than about 70 wt. %.

In an optional embodiment, the coating may include at least one epoxy-functional component, e.g., an aromatic-epoxy-functional component (“aromatic epoxy or more preferably an aliphatic epoxy-functional component (“aliphatic epoxy”). Epoxy-functional components are components comprising one or more epoxy groups, i.e., one or more three-member ring structures (oxiranes).

Aromatic epoxy components include one or more epoxy groups and one or more aromatic rings. The coating may include one or more aromatic epoxy components. An example of an aromatic epoxy component includes an aromatic epoxy derived from a polyphenol, e.g., from bisphenols, such as bisphenol A (4,4′-isopropylidenediphenol), bisphenol F (bis[4-hydroxyphenyl]methane), bisphenol S (4,4′-sulfonyldiphenol), 4,4′-cyclohexylidenebisphenol, 4,4′-biphenol, or 4,4′-(9-fluorenylidene)diphenol. The bisphenol may be alkoxylated (e.g., ethoxylated or propoxylated) or halogenated (e.g., brominated). Examples of bisphenol epoxies include bisphenoldiglycidyl ethers, such as diglycidyl ether of Bisphenol A or Bisphenol F.

A further example of an aromatic epoxy includes triphenylolmethanetriglycidyl ether, 1,1, 1-tris(p-hydroxyphenyl)ethane triglycidyl ether, or an aromatic epoxy derived from a monophenol, e.g., from resorcinol (for example, resorcindiglycidyl ether) or hydroquinone (for example, hydroquinone diglycidyl ether). Another example is nonylphenylglycidyl ether.

In addition, an example of an aromatic epoxy includes epoxy novolac, for example, phenol epoxy novolac and cresol epoxy novolac. A commercial example of a cresol epoxy novolac includes, for example, EPICLON N-660, N-665, N-667, N-670, N-673, N-680, N-690, or N-695, manufactured by Dainippon Ink and Chemicals, Inc. An example of a phenol epoxy novolac includes, for example, EPICLON N-740, N-770, N-775, or N-865, manufactured by Dainippon Ink and Chemicals Inc.

In one embodiment, the coating may contain, relative to the total weight of the composite coating formulation, at least 10 wt. % of one or more aromatic epoxies.

Aliphatic epoxy components have one or more epoxy groups and are free of aromatic rings. The coating may include one or more aliphatic epoxies. An example of an aliphatic epoxy includes glycidyl ether of C2-C30 alkyl; 1,2 epoxy of C3-C30 alkyl; mono or multi glycidyl ether of an aliphatic alcohol or polyol such as 1,4-butanediol, neopentyl glycol, cyclohexane dimethanol, dibromoneopentyl glycol, trimethylol propane, polytetramethylene oxide, polyethylene oxide, polypropylene oxide, glycerol, and alkoxylated aliphatic alcohols; or polyols.

In one embodiment, the aliphatic epoxy includes one or more cycloaliphatic ring structures. For example, the aliphatic epoxy may have one or more cyclohexene oxide structures, for example, two cyclohexene oxide structures. An example of an aliphatic epoxy comprising a ring structure includes hydrogenated bisphenol A diglycidyl ether, hydrogenated bisphenol F diglycidyl ether, hydrogenated bisphenol S diglycidyl ether, bis(4-hydroxycyclohexyl)methane diglycidyl ether, 2,2-bis(4-hydroxycyclohexyl)propanediglycidyl ether, 3,4-epoxycyclohexylmethyl-3,4-epoxycyclohexanecarboxylate, 3,4-5epoxy-6-methylcyclohexylmethyl-3,4-epoxy-6-methylcyclohexanecarboxylate, di(3,4-epoxycyclohexylmethyl)hexanedioate, di(3,4-epoxy-6-methylcyclohexyl methyl)hexanedioate, ethylenebis(3,4-epoxycyclohexanecarboxylate), ethanedioldi(3,4-epoxycyclohexylmethyl)ether, or 2-(3,4-epoxycyclohexyl-5,5-spiro-3,4-epoxy)cyclohexane-1,3-dioxane.

In an embodiment, the coating includes, relative to the total weight of the composite coating formulation, at least about 5 wt. % of one or more aliphatic epoxies, for example, at least about 10 wt. % or at least about 20 wt. % of the aliphatic epoxy. Generally, the coating includes, relative to the total weight of the composite coating formulation, not greater than about 70 wt. % of the aliphatic epoxy, for example, not greater than about 50 wt. %, for example not greater than about 40 wt. %.

Typically, the coating includes one or more mono or poly glycidyl ethers of aliphatic alcohols, aliphatic polyols, polyesterpolyols or polyetherpolyols. An example of such a component includes 1,4-butanedioldiglycidyl ether, glycidyl ether of polyoxyethylene or polyoxypropylene glycol or triol of molecular weight from about 200 to about 10,000; glycidyl ether of polytetramethylene glycol or poly(oxyethyleneoxybutylene) random or block copolymers. An example of commercially available glycidyl ether includes a polyfunctional glycidyl ether, such as Heloxy 48, Heloxy 67, Heloxy 68, Heloxy 107, and Grilonit F713; or monofunctional glycidyl ethers, such as Heloxy 71, Heloxy 505, Heloxy 7, Heloxy 8, and Heloxy 61 (sold by Resolution Performances, www.resins.com).

The coating may contain about 3 wt. % to about 40 wt. %, more typically about 5 wt. % to about 20 wt. % of mono or poly glycidyl ethers of an aliphatic alcohol, aliphatic polyol, polyesterpolyol or polyetherpolyol.

The coating may include one or more oxetane-functional components (“oxetanes”). Oxetanes are components having one or more oxetane groups, i.e., one or more four-member ring structures including one oxygen and three carbon members.

In addition to or instead of one or more cationically curable components, the coating may include one or more free radical curable components, e.g., one or more free radical polymerizable components having one or more ethylenically unsaturated groups, such as (meth)acrylate (i.e., acrylate or methacrylate) functional components.

An example of a monofunctional ethylenically unsaturated component includes acrylamide, N,N-dimethylacrylamide, (meth)acryloylmorpholine, 7-amino-3,7-dimethyloctyl(meth)acrylate, isobutoxymethyl(meth)acrylamide, isobornyloxyethyl (meth)acrylate, isobornyl(meth)acrylate, 2-ethylhexyl(meth)acrylate, ethyldiethyleneglycol (meth)acrylate, t-octyl(meth)acrylamide, diacetone (meth)acrylamide, dimethylaminoethyl(meth)acrylate, diethylaminoethyl(meth)acrylate, lauryl (meth)acrylate, dicyclopentadiene (meth)acrylate, dicyclopentenyloxyethyl(meth)acrylate, dicyclopentenyl(meth)acrylate, N,N-dimethyl(meth) acrylamidetetrachlorophenyl(meth)acrylate, 2-tetrachlorophenoxyethyl (meth)acrylate, tetrahydrofurfuryl(meth)acrylate, tetrabromophenyl(meth)acrylate, 2-tetrabromophenoxyethyl (meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, butoxyethyl(meth)acrylate, pentachlorophenyl(meth)acrylate, pentabromophenyl(meth)acrylate, polyethylene glycolmono(meth)acrylate, polypropylene glycol mono(meth)acrylate, bornyl(meth)acrylate, methyltriethylenediglycol (meth)acrylate, or a combination thereof.

An examples of the polyfunctional ethylenically unsaturated component includes ethylene glycol di(meth)acrylate, dicyclopentenyl di(meth)acrylate, triethylene glycoldiacrylate, tetraethylene glycol di(meth)acrylate, tricyclodecanediyldimethylenedi(meth)acrylate, trimethylolpropane tri(meth)acrylate, ethoxylatedtrimethylolpropanetri(meth)acrylate, propoxylatedtrimethylolpropane tri(meth)acrylate, tripropylene glycoldi(meth)acrylate, neopentyl glycol di(meth)acrylate, both-terminal (meth)acrylic acid adduct of bisphenol A diglycidyl ether, 1,4-butanediol di(meth)acrylate, 1,6-hexanedioldi(meth)acrylate, polyethylene glycol di(meth)acrylate, (meth)acrylate-functional pentaerythritol derivatives (e.g., pentaerythritol tri(meth)acrylate, pentaerythritoltetra(meth)acrylate, dipentaerythritolhexa(meth)acrylate, dipentaerythritolpenta(meth)acrylate, or dipentaerythritol tetra(meth)acrylate), ditrimethylolpropanetetra(meth)acrylate, ethoxylated bisphenol A di(meth)acrylate, propoxylated bisphenol A di(meth)acrylate, ethoxylated hydrogenated bisphenol A di(meth)acrylate, propoxylated-modified hydrogenated bisphenol A di(meth)acrylate, ethoxylated bisphenol F di(meth)acrylate, or a combination thereof.

In one embodiment, the coating formulation comprises one or more components having at least 3 (meth)acrylate groups, for example, 3 to 6 (meth)acrylate groups or 5 to 6 (meth)acrylate groups.

In particular embodiments, the coating includes, relative to the total weight of the composite coating formulation, at least about 3 wt. % of one or more free radical polymerizable components, for example, at least about 5 wt. %, for example at least about 9 wt. %. Generally, the coating includes not greater than about 50 wt. % of free radical polymerizable components, for example, not greater than about 3 5 wt. %, for example, not greater than about 25 wt. %, for example not greater than about 20 wt. %, for example not greater than about 15 wt. %.

Generally, the polymer reaction constituents or precursors have on average at least two functional groups, such as on average at least 2.5, for example at least 3.0 functional groups. For example, an epoxy precursor may have 2 or more epoxy-functional groups. In another example, an acrylic precursor may have two or more methacrylate functional groups.

It has been found that a coating including a component having a polyether backbone shows excellent mechanical properties after cure of the composite coating formulation. An example of a compound having a polyether backbone includes polytetramethylenediol, a glycidyl ether of polytetramethylenediol, an acrylate of polytetramethylenediol, a polytetramethylenediol containing one or more polycarbonate groups, or a combination thereof. In an embodiment, the coating includes between 5 wt. % and 20 wt. % of a compound having a polyether backbone.

The coating may also include catalysts and initiators. For example, a cationic initiator may catalyze reactions between cationic polymerizable constituents. A radical initiator may activate free-radical polymerization of radically polymerizable constituents. The initiator may be activated by thermal energy or actinic radiation. For example, an initiator may include a cationic photoinitiator that catalyzes cationic polymerization reactions when exposed to actinic radiation. In another example, the initiator may include a radical photoinitiator that initiates free-radical polymerization reactions when exposed to actinic radiation. Actinic radiation includes particulate or non-particulate radiation and is intended to include electron beam radiation and electromagnetic radiation. In a particular embodiment, electromagnetic radiation includes radiation having at least one wavelength in the range of about 100 nm to about 700 nm and, in particular, wavelengths in the ultraviolet range of the electromagnetic spectrum.

Generally, cationic photoinitiators are materials that form active species that, if exposed to actinic radiation, are capable of at least partially polymerizing epoxides or oxetanes. For example, a cationic photoinitiator may, upon exposure to actinic radiation, form cations that can initiate the reactions of cationically polymerizable components, such as epoxies or oxetanes.

An example of a cationic photoinitiator includes, for example, onium salt with anions of weak nucleophilicity. An example includes a halonium salt, an iodosyl salt or a sulfonium salt, a sulfoxonium salt, or a diazonium salt. Other examples of cationic photoinitiators include metallocene salt.

The coating may optionally include photoinitiators useful for photocuring free-radically polyfunctional acrylates. An example of a free radical photoinitiator includes benzophenone (e.g., benzophenone, alkyl-substituted benzophenone, or alkoxy-substituted benzophenone); benzoin (e.g., benzoin, benzoin ethers, such as benzoin methyl ether, benzoin ethyl ether, and benzoin isopropyl ether, benzoin phenyl ether, and benzoin acetate); acetophenone, such as acetophenone, 2,2-dimethoxyacetophenone, 4-(phenylthio)acetophenone, and 1,1-dichloroacetophenone; benzil ketal, such as benzyl dimethyl ketal, and benzil diethyl ketal; anthraquinone, such as 2-methylanthraquinone, 2-ethylanthraquinone, 2-tertbutylanthraquinone, 1-chloroanthraquinone, and 2-amylanthraquinone; triphenylphosphine; benzoylphosphine oxides, such as, for example, 2,4,6-trimethylbenzoyldiphenylphosphine oxide; thioxanthone or xanthone; acridine derivative; phenazene derivative; quinoxaline derivative; 1-phenyl-1,2-propanedione-2-O-benzoyloxime; 1-aminophenyl ketone or 1-hydroxyphenyl ketone, such as 1-hydroxycyclohexyl phenyl ketone, phenyl(1-hydroxyisopropyl)ketone and 4-isopropylphenyl(1-hydroxyisopropyl)ketone; or a triazine compound, for example, 4′″-methyl thiophenyl-1-di(trichloromethyl)-3,5-S-triazine, S-triazine-2-(stilbene)-4,6-bistrichloromethyl, or paramethoxystyryltriazine.

Example photoinitiators include benzoin or its derivative such as α-methylbenzoin; U-phenylbenzoin; α-allylbenzoin; α-benzylbenzoin; benzoin ethers such as benzil dimethyl ketal (available, for example, under the trade designation “IRGACURE651” from Ciba Specialty Chemicals), benzoin methyl ether, benzoin ethyl ether, benzoin n-butyl ether; acetophenone or its derivative, such as 2-hydroxy-2-methyl-1-phenyl-1-propanone (available, for example, under the trade designation “DAROCUR 1173” from Ciba Specialty Chemicals) and 1-hydroxycyclohexyl phenyl ketone (available, for example, under the trade designation “IRGACURE 184” from Ciba Specialty Chemicals); 2-methyl-1-[4-(methylthio) phenyl]-2-(4-morpholinyl)-1-propanone (available, for example, under the trade designation “IRGACURE 907” from Ciba Specialty Chemicals); 2-benzyl-2-(dimethlamino)-1[4-(4-morpholinyl) phenyl]-1-butanone (available, for example, under the trade designation “IRGACURE 369” from Ciba Specialty Chemicals); or a blend thereof.

Another useful photoinitiator includes pivaloin ethyl ether, anisoin ethyl ether; anthraquinones, such as anthraquinone, 2-ethylanthraquinone, 1-chloroanthraquinone, 1,4-dimethylanthraquinone, 1-methoxyanthraquinone, benzanthraquinonehalomethyltriazines, and the like; benzophenone or its derivative; iodonium salt or sulfonium salt as described hereinabove; a titanium complex such as bis(5-2,4-cyclopentadienyl)bis[2,-6-difluoro-3-(1H-pyrrolyl)phenyl)titanium (commercially available under the trade designation“CG1784DC”, also from Ciba Specialty Chemicals); a halomethylnitrobenzene such as 4-bromomethylnitrobenzene and the like; or mono- or bis-acylphosphine (available, for example, from Ciba Specialty Chemicals under the trade designations “IRGACURE1700”, “IRGACURE 1800”, “IRGACURE 1850”, and “DAROCUR 4265”). A suitable photoinitiator may include a blend of the above mentioned species, such as α-hydroxyketone/acrylphosphin oxide blend (available, for example, under the trade designation IRGACURE 2022 from Ciba Specialty Chemicals).

A further suitable free radical photoinitiator includes an ionic dye-counter ion compound, which is capable of absorbing actinic rays and producing free radicals, which can initiate the polymerization of the acrylates.

A photoinitiator can be present in an amount not greater than about 20 wt. %, for example, not greater than about 10 wt. %, and typically not greater than about 5 wt. %, based on the total weight of the coating formulation. For example, a photoinitiator may be present in an amount of 0.1 wt. % to 20.0 wt. %, such as 0.1 wt. % to 5.0 wt. %, or most typically 0.1 wt. % to 2.0 wt. %, based on the total weight of the coating formulation, although amounts outside of these ranges may also be useful. In one example, the photoinitiator is present in an amount at least about 0.1 wt. %, such as at least about 1.0 wt. %, for example in an amount 1.0 wt. % to 10.0 wt. %.

Optionally, a thermal curative may be included in the coating. Such a thermal curative is generally thermally stable at temperatures at which mixing of the components takes place. Thermal curatives for epoxy resins and acrylates are well known in the art. A thermal curative may be present in a coating precursor in any effective amount. Such amounts are typically in the range of about 0.01 wt. % to about 5.0 wt. %, desirably in the range from about 0.025 wt. % to about 2.0 wt. % by weight, based upon the weight of the coating formulation, although amounts outside of these ranges may also be useful.

The coating may also include other components such as solvents, plasticizers, crosslinkers, chain transfer agents, stabilizers, surfactants, curing agents, reaction mediators and agents for influencing the fluidity of the dispersion. For example, the coating can also include one or more chain transfer agents selected from the group consisting of polyol, polyamine, linear or branched polyglycol ether, polyester and polylactone.

In another example, the coating may include additional components, such as a hydroxy-functional or an amine functional component and additive. Generally, the particular hydroxy-functional component is absent curable groups (such as, for example, acrylate-, epoxy-, or oxetane groups) and is not selected from the group consisting of photoinitiators.

The coating may include one or more hydroxy-functional components. Hydroxy-functional components may be helpful in further tailoring mechanical properties of the coating formulation upon cure. An hydroxy-functional component includes monol (ahydroxy-functional component comprising one hydroxy group) or polyol (a hydroxy functional component comprising more than one hydroxy group).

A representative example of a hydroxy-functional component includes an alkanol, a monoalkyl ether of polyoxyalkyleneglycol, a monoalkyl ether of alkyleneglycol, alkylene and arylalkylene glycol, such as 1,2,4-butanetriol, 1,2,6-hexanetriol, 1,2,3-heptanetriol, 2,6-dimethyl-1,2,6-hexanetriol, (2R,3R)-(−)-2-benzyloxy-1,3,4-butanetriol, 1,2,3-hexanetriol, 1,2,3-butanetriol, 3-methyl-1,3,5-pentanetriol, 1,2,3-cyclohexanetriol, 1,3,5-cyclohexanetriol, 3,7,11,15-tetramethyl-1,2,3-hexadecanetriol, 2-hydroxymethyltetrahydropyran-3,4,5-triol, 2,2,4,4-tetramethyl-1,3-cyclobutanediol, 1,3-cyclopentanediol, trans-1,2-cyclooctanediol, 1,16-hexadecanediol, 3,6-dithia-1,8-octanediol, 2-butyne-1,4-diol, 1,2- or 1,3-propanediol, 1,2- or 1,4-butanediol, 1,5-pentanediol, 1,6-hexanediol, 1,7-heptanediol, 1,8-octanediol, 1,9-nonanediol, 1-phenyl-1,2-ethanediol, 1,2-cyclohexanediol, 1,5-decalindiol, 2,5-dimethyl-3-hexyne-2,5-diol, 2,2,4-trimethylpentane-1,3-diol, neopentylglycol, 2-ethyl-1,3-hexanediol, 2,7-dimethyl-3,5-octadiyne-2-7-diol, 2,3-butanediol, 1,4-cyclohexanedimethanol, polyoxyethylene or polyoxypropylene glycols or triols of molecular weights from about 200 to about 10,000, polytetramethylene glycols of varying molecular weight, poly(oxyethylene-oxybutylene) random or block copolymers, copolymers containing pendant hydroxy groups formed by hydrolysis or partial hydrolysis of vinyl acetate copolymers, polyvinylacetal resins containing pendant hydroxyl groups, hydroxy-functional (e.g., hydroxy-terminated) polyesters or hydroxy-functional (e.g., hydroxy-terminated) polylactones, aliphatic polycarbonate polyols (e.g., an aliphatic polycarbonate diol), hydroxy-functional (e.g., hydroxy-terminated) polyethers (e.g., polytetrahydrofuran polyols having a number average molecular weight in the range of 150-4000 g/mol, 150-1500 g/mol, or 150-750 g/mol), or a combination thereof. Polyols can further include aliphatic polyol, such as glycerol, trimethylolpropane, and also sugar alcohol, such as erythritol, xylitol, mannitol or sorbitol. In particular embodiments, the coating of the coating formulation includes one or more alicyclic polyols, such as 1,4-cyclohexane-dimethanol, sucrose, or 4,8-bis(hydroxymethyl)tricyclo(5,2,1,0)decane.

A suitable polyether for the coating includes, in particular, linear or branched polyglycol ether obtainable by ring-opening polymerization of cyclic ether in the presence of polyol, e.g., the aforementioned polyol; polyglycol ether, polyethylene glycol, polypropylene glycol or polytetramethylene glycol or a copolymer thereof.

Another suitable polyester for the coating of the formulation includes a polyester based on polyols and aliphatic, cycloaliphatic or aromatic polyfunctional carboxylic acids (for example, dicarboxylic acids), or specifically all corresponding saturated polyesters which are liquid at temperatures of 18° C. to 300° C., typically 18° C. to 150° C.: typically succinic ester, glutaric ester, adipic ester, citric ester, phthalic ester, isophthalic ester, terephthalic ester or an ester of corresponding hydrogenation products, with the alcohol component being composed of monomeric or polymeric polyols, for example, of those of the above-mentioned kind.

Further polyester includes aliphatic polylactone, such as α-polycaprolactone, or polycarbonate, which, for example, are obtainable by polycondensation of diol with phosgene. For the coating it is typical to use polycarbonate of bisphenol A having an average molecular weight of from 500 to 100,000.

For the purpose of influencing the viscosity of the coating and, in particular, viscosity reduction or liquefaction, the polyol, polyether or saturated polyester or mixtures thereof may, where appropriate, be admixed with a further suitable auxiliary, particularly a solvent, a plasticizer, a diluent or the like. In an embodiment, the compositions may comprise, relative to the total weight of the coating formulation, not greater than about 15 wt. %, such as not greater than about 10 wt. %, not greater than about 6 wt. %, not greater than about 4 wt. %, not greater than about 2 wt. %, or about 0 wt. % of a hydroxy-functional component. In one example, the coating formulations are free of substantial amounts of a hydroxy-functional component. The absence of substantial amounts of hydroxy-functional components may decrease the hygroscopicity of the coating formulations or articles obtained therewith.

An example of a hydroxyl or an amine functional organic compound for making condensation product with an alkylene oxide includes a polyol having 3 to 20 carbon atoms, a (C8-C18) fatty acid (C1-C8) alkanol amides like fatty acid ethanol amides, a fatty alcohol, an alkylphenol or a diamine having 2 to 5 carbon atoms. Such compounds are reacted with alkylene oxide, such as ethylene oxide, propylene oxide or mixtures thereof. The reaction may take place in a molar ratio of hydroxy or amine containing organic compound to alkyleneoxide of, for example, 1:2 to 1:65. The condensation product typically has a weight average molecular weight of about 500 to about 10,000, and may be branched, cyclic, linear, and either a homopolymer, a copolymer or a terpolymer.

In an example the coating includes an ionic surfactant and a non-ionic surfactant. In general, surfactants are configured for interacting with and modifying the surface of the particulate filler. The non-ionic surfactant can include one or more reactive groups that can be chemically bonded to a polymer matrix by a curing process, and wherein the polymer matrix is formed of cationically and radically polymerizable compounds. The one or more reactive groups can include vinyl, hydroxyl, carboxyl, acrylic, epoxy, urethane, amine, and wherein the curing process includes, UV, thermal, moisture, or chemical crosslinking. For example, a non-ionic surfactant may include organosiloxane, functionalized organosiloxane, alkyl-substituted pyrrolidone, polyoxyalkylene ether, ethyleneoxidepropylene oxide copolymer or a combination thereof. For various particulate fillers and, in particular, for silica filler, a suitable surface modifier includes siloxane.

In general, the functionalized siloxane is a compound having a molecular weight ranging from about 300 to about 20,000. Such compounds are commercially available from, for example, the General Electric Company or from Goldschmidt, Inc. A typical functionalized siloxane is an amine functionalized siloxane wherein the functionalization is typically terminal to the siloxane.

Organosiloxanes are sold under the name Silwet by Witco Corporation. Such organosiloxanes typically have an average weight molecular weight of about 350 to about 15,000, are hydrogen or C1-C4 alkyl capped and may be hydrolyzable or non-hydrolyzable. Typical organosiloxanes include those sold under the name of Silwet L-77, L-7602, L-7604 and L-7605, which are polyalkylene oxide modified dialkylpolysiloxanes.

An example of a suitable ionic surfactant includes (C8-C16)alkylbenzenesulfonate, (C8-C16)alkane sulfonate, (C8-C18) α-olefin sulfonate, α-sulfo (C8-C16) fatty acid methyl ester, (C8-C16) fatty alcohol sulfate, mono- or di-alkyl sulfosuccinate with each alkyl independently being a (C8-C16)alkyl group, alkyl ether sulfate, a (C8-C16) salt of carboxylic acid or isethionate having a fatty chain of about 8 to about 18 carbons, for example, sodium diethylhexyl sulfosuccinate, sodium methyl benzene sulfonate, or sodium bis(2-ethylhexyl)sulfosuccinate (for example, Aerosol OT or AOT).

In a preferred example, the ionic surfactant is dioctyl sulfosuccinate sodium salt (DSS), which has the following chemical structure:

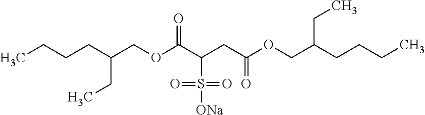

The ionic surfactant can be at least marginally soluble in isopropanol (IPA). For example, the ionic surfactant can dissolve such that the coating composition is transparent. In an example, about 0.2 grams, about 0.3 grams, about 0.5 grams, about 0.6 grams, about 0.7 grams, 0.8 grams of DSS can dissolve in about 1.0 gram of IPA. The ionic surfactant can be dissolvable in a solution including at least one of IPA, methanol, and water.

The non-ionic surfactant can be a compound selected from an organosiloxane, a functionalised organosiloxane, an alkyl-substituted pyrrolidone, a polyoxyalkylene ether, or a ethyleneoxide propylenenoxide block copolymer.

An example of a commercial surfactant includes a cyclic organo-silicone (e.g., SF1204, SF1256, SF1328, SF1202 (decamethyl-cyclopentasiloxane(pentamer)), SF1258, SF1528, Dow Corning 245 fluids, Dow Corning 246 fluids, dodecamethyl-cyclo-hexasiloxane (heximer), and SF 1173); a copolymer of a polydimethylsiloxane and a polyoxyalkylene oxide (e.g., SF1488 and SF1288); linear silicon comprising oligomers (e.g., Dow Corning 200® fluids); Silwet L-7200, Silwet L-7600, Silwet L-7602, Silwet L-7605, Silwet L-7608, or Silwet L-7622; a nonionic surfactants (e.g., Triton X-100, Igepal CO-630, PVP series, Airvol 125, Airvol 305, Airvol 502 and Airvol 205); an organic polyether (e.g., Surfynol 420, Surfynol 440 and Surfynol 465); or Solsperse 41000.

Another commercial non-ionic surfactant includes SF1173 (from GE Silicones); an organic polyether like Surfynol 420, Surfynol 440, and Surfynol 465 (from Air Products Inc); Silwet L-7200, Silwet L-7600, Silwet L-7602, Silwet L-7605, Silwet L-7608, or Silwet L-7622 (from Witco) or non-ionic surfactant such as Triton X-100 (from Dow Chemicals), Igepal CO-630 (from Rhodia), PVP series (from ISP Technologies) and Solsperse 41000 (from Avecia).

The amount of ionic surfactant ranges from 0 wt. % to 10 wt. %. More typically, the amount of surfactant is between 0.1 wt. % and 5 wt. %. The silanes are typically used in concentrations from 40 mol. % to 200 mol. % and, particularly, 60 mol. % to 150 mol. % relative to the molecular quantity surface active sites on the surface of the nano-sized particulate filler. Generally, the coating formulation includes not greater than about 20 wt. % surfactant, including the ionic surfactant and the non-ionic surfactant, such as about 0.1 wt. % to about 10.0 wt. % surfactant, based on the total weight of the coating formulation. In an example, the coating formulation can have an ionic surfactant to non-ionic surfactant weight ratio (e.g., ionic:non-ionic) of about 1:50 to about 1:1, preferably about 1:30 to about 1:1, including 1:5, 1:4, 1:3, 1:2, 1:1.

In a particular embodiment, the coating formulation includes about 10 wt. % to about 90 wt. % cationically polymerizable compound, not greater than about 40 wt. % radically polymerizable compound, and about 5 wt. % to about 80 wt. % particulate filler, based on the total weight of the coating formulation. It is understood that the sum of the amounts of the coating formulation components adds to 100 wt. % and, as such, when amounts of one or more components are specified, the amounts of other components correspond so that the sum of the amounts is not greater than 100 wt. %. In an embodiment, a weight ratio of the cationically polymerizable compound to the radically polymerizable compound is from about 1:1 to about 2:1.

The cationically polymerizable compound, for example, includes an epoxy-functional component or an oxetane-functional component. For example, the coating formulation may include about 10 wt. % to about 60 wt. % cationically polymerizable compound, such as about 20 wt. % to about 50 wt. % cationically polymerizable compound based on the weight of the coating formulation. The example coating formulation may include not greater than about 20 wt. %, such as about 5 wt. % to about 20 wt. % mono or poly glycidyl ethers of an aliphatic alcohol, aliphatic polyols, polyesterpolyol or polyetherpolyol. The example coating formulation may include not greater than about 50 wt. %, such as about 5 wt. % to about 50 wt. % of a component having a polyether backbone, such as polytetramethylenediol, glycidyl ethers of polytetramethylenediol, and acrylates of polytetramethylenediol or polytetramethylenediol containing one or more polycarbonate groups.

The radically polymerizable compound of the above example, for example, includes components having one or more methacylate groups, such as components having at least 3 methacrylate groups. In another example, the coating formulation includes not greater than about 30 wt. %, such as not greater than about 20 wt. %, not greater than about 10 wt. % or not greater than about 5 wt. % radically polymerizable compound.

The formulation may further include not greater than about 20 wt. % cationic photoinitiator, such as about 0.1 wt. % to about 20 wt. %, or not greater than about 20 wt. % radical photoinitiator, such as about 0.1 wt. % to about 20 wt. %. For example, the coating formulation may include not greater than about 10 wt. %, such as not greater than about 5 wt. % cationic photoinitiator. In another example, the coating formulation may include not greater than about 10 wt. %, such as not greater than about 5 wt. % free radical photoinitiator.

The particular filler includes dispersed submicron particulates. Generally, the coating formulation includes 5 wt. % to 80 wt. %, such as 5 wt. % to 60 wt. %, such as 5 wt. % to 50 wt. %, for example, 20 wt. % to 45 wt. % submicron particulate filler. Particular embodiments include at least about 5 wt. % particulate filler, for example at least about 10 wt. %, such as at least about 20 wt. %. In a particular embodiment, the particulate filler is solution formed silica particulate and may be colloidally dispersed in a polymer component. The example coating formulation may further include not greater than about 5 wt. % surfactant, such as 0.1 wt. % to 5 wt. % surfactant, selected from organosiloxane, functionalised organosiloxane, alkyl-substituted pyrrolidone, polyoxyalkylene ether, and ethyleneoxidepropylenenoxide block copolymer.

In a particular embodiment, the coating formulation is formed by mixing a nanocomposite epoxy or acrylate precursor, i.e., a precursor including submicron particulate filler. For example, the coating formulation may include not greater than about 90 wt. % nanocomposite epoxy and may include acrylic precursor, such as not greater than 50 wt. % acrylic precursors. In another example, a nanocomposite acrylic precursor maybe mixed with epoxy.

The coating formulation including an coating comprising polymeric or monomeric constituents and including dispersed particulate filler may be used to form a coating that is applied to a surface of the ophthalmic lens, it is exposed to radiation preferably in the ultraviolet range. Such radiation exposure causes the radically polymerizable polymer to rapidly cure creating a structure or lattice that retains the cationically polymerized polymer in place while it undergoes a slower photo curing process. As a result the cationically polymerized polymer cures in localized, encapsulated environments as it is retained by the quickly cured radically polymerizable polymer.

The coating system described herein is stable at room temperature and includes a reduced solvent concentration thereby reducing the overall VOC impact of the material. The coating system is formed as an epoxy/acrylate cationic hybrid coating that includes two polymerization initiators, one of which commences polymerization upon exposure to ultraviolet radiation, while the other is a photo initiated catalyst. The coating may be further enhanced by the addition of colloidal nano-silica particles, such as Nanocryl C150 (e.g. reactive diluent/SiO₂), that serve to reinforce the mechanical properties of the coating system without compromising the overall transparency and optical clarity of the coating.

Further by employing a coating system such as described herein the epoxy/acrylate coating system is compatible with most dyes in a manner that allows the incorporation of infrared and near infrared energy filtering as well as the incorporation of other coating additives that serve to enhance the cleaning, anti-fogging and anti-reflective properties of the ophthalmic lens.

It is further preferred that the particular polymer substrate for the ophthalmic lens selected be well suited to the application in which the finished optical filter will be employed. For example, lens blanks are typically formed using a polycarbonate while windows are formed using acrylic. In practical application, the filter blank is formed for further use as lens blanks, lenses for eyewear, windows and filtering plates.

It can therefore be seen that the coatings described herein provide a lens coating system that can be rapidly cured, offers the advantages of acrylate coatings yet has improved mechanical properties such as abrasion resistance. Further, the coating system described herein can be configured for application to a polymer ophthalmic lens that has improved abrasion resistance of the level of an epoxy coating, rapid curing of a radiation cured coating, while also being stable a room temperature, exhibiting low solvent/VOC content and supporting additives for features such as anti-fog, easy cleaning, anti-reflection and targeted wavelength filtering. For these reasons, the instant application is believed to represent a significant advancement in the art, which has substantial commercial merit.

A method for forming an anti-fog coated surface is described herein. The method can include preparing an anti-fog coating, such as described herein, including, but not limited to, a cationically polymerizable compound including at least one epoxy group, a radically polymerizable compound including at least one acrylate group, a non-ionic surfactant, and an ionic surfactant. In an example, preparing can include combining a cationic polymerization initiator and a free radical polymerization initiator with the cationically polymerizable compound.

The method of forming the anti-fog coated surface can include applying the anti-fog coating to a surface, such as dip-coating, spin-coating, spray-coating, and a doctor blade process. In an example, the method can include multiple applications of the anti-fog coating, such as prior to, during, or after a curing process.

In an example, the method includes curing the anti-fog coating on the surface to form an anti-fog coated surface. The surface can include the substrate as described herein, including, but not limited to, an ophthalmic lens of eyeglasses, a television screen, or a face shield. Curing the anti-fog coating includes polymerization. For example, curing can include exposing the cationic polymerization initiator to ultraviolet radiation, thermal energy, or actinic to cause polymerization of the cationically polymerizable compound and exposing the free radical polymerization initiator to the ultraviolet radiation, the thermal energy, or the actinic radiation to cause polymerization of the radically polymerizable compound. In an example, curing can include using ultraviolet radiation, thermal energy, or actinic radiation.

In an example, the curing process can cause the anti-fog coated surface to be partially non-transparent (e.g., not clear). The present method includes, in an example, washing the anti-fog coated surface. Washing can include contacting the anti-fog coated surface with water, such as by soaking (e.g., immersing) the anti-fog coated surface from about 1 second to about 1 minute, or misting with water. The anti-fog coated surface can be immersed in water more than once. During the washing process at least a portion of the ionic surfactant is removed from the anti-fog coated surface. For example, a portion of the ionic surfactant that did not dissolve in the IPA can be removed from the anti-fog coated surface. The washing process can, in an example, improve the clarity or transparency of the anti-fog coated surface. The water used for washing the anti-fog coated surface can be from about room temperature (e.g., about 20° C. to about 80° C.). In an example, the method can include drying the anti-fog coated surface, such as by air drying.

### Prophetic Examples

### Comparative Anti-Fog Performance Examples (Prophetic)

A UV curable epoxy/acrylate hybrid coating composition as illustrated in example 1.1, 1.2, 1.3, and 1.4 respectively. Each coating is coated on the 76 mm polycarbonate lens blanks and followed by UV cure with combined Fusion D and H lamps at 50 ft/minute to give a dry thickness of 2 microns. Anti-fog coating from each composition is tested by the EN 166/168 Resistance to Fogging Internal Screening Test, and if a clear water film forms on the coating surface instead of fogging, it is considered as a good anti-fog coating. The composition without DSS will be used as reference to compare the effect of DSS. The detailed compositions, in grams, and anti-fog performance are summarized in the table below.

| Component | Example 1.1 | Example 1.2 | Example 1.3 | Example1.4 | Example 1.5 |
|---|---|---|---|---|---|
| ACHWL 4221 (difunctional | 14.67 | 14.67 | 14.67 | 14.67 | 14.67 |
| cycloaliphatic epoxy) | | | | | |
| poly(ethylene glycol) | 0.00 | 0.00 | 0.00 | 0.00 | 0.00 |
| diglycidyl ether (MN 500) | | | | | |
| OXT-101 | 4.50 | 4.50 | 4.50 | 4.50 | 4.50 |
| Chivacure 1176 (Chitec) | 0.63 | 0.63 | 0.63 | 0.63 | 0.63 |
| PEGMA (Mn 500) | | | | | |
| PEGMA-ME (Mn 480) | | | | | |
| PEGDA (Mn 575) | 30.40 | 30.40 | 30.40 | 30.40 | 30.40 |
| Nanocryl c150 *reactive | 8.00 | 8.00 | 8.00 | 8.00 | 8.00 |
| diluent/SiO₂) | | | | | |
| Chivacure 184 (free-radical | 0.45 | 0.45 | 0.45 | 0.45 | 0.45 |
| initiator) | | | | | |
| IPA | 35.24 | 35.24 | 35.24 | 35.24 | 35.24 |
| Poly(ethylene glycol) | 0.00 | 0.00 | 3.00 | 3.00 | 3.00 |
| dioleate PEGDO | | | | | |
| (Mn 1120) | | | | | |
| DSS | 0.00 | 3.00 | 3.00 | 1.00 | 2.00 |
| Total (grams) | 96.89 | 96.89 | 99.89 | 97.89 | 98.89 |
| anti-fog performance- warm | Fog | Fog | Fog | Fog | Fog |
| mist | | | | | |
| anti-fog performance - EN | Fog - Non- | Fog - Non- | No Fog | | |
| 166 - 30 minutes | uniform | uniform | | | |
| | Film | Film | | | |
| anti-fog performance - EN | Fog - Non- | Fog - Non- | No Fog | No Fog | No Fog |
| 166 - 60 minutes | uniform | uniform | | | |
| | Film | Film | | | |
| anti-fog performance - EN | Fog - Non- | Fog - Non- | No Fog | No Fog | No Fog |
| 166 - 120 minutes | uniform | uniform | | | |
| | Film | Film | | | |

Accordingly, coating compositions for anti-fog coatings, methods for coating a surface to provide an anti-fog coated surface, and coated transparent polymeric materials have been described. In an embodiment, an improved coating system for transparent polymeric materials, such as ophthalmic lenses, provides improved characteristics in the form of anti-fog performance and scratch or abrasion resistance, and mitigation of surfactant diffusion, while also providing improved manufacturability and rapid curing as compared to prior art coating systems. Generally, the coating system is a composite coating that hybridizes both epoxy and acrylate coating materials into a single coating system with an ionic and a non-ionic surfactant. In this manner, the coating system exhibits the mechanical properties imparted by epoxies creating a highly abrasion resistant coating while also including the advantageous properties of radiation cured coatings imparted by acrylates in the form of rapid processing and curing as well as a superior vehicle for carrying additives. The ionic surfactant includes DSS. The anti-fog coating is applied to a surface, such as of a transparent polymeric material, and is polymerized to form an anti-fog coated surface. When moisture condenses onto the surface of the coated transparent polymeric material, the composite coating exhibits photo-induced hydrophilic and self-cleaning properties to impart long-lasting anti-fog performance to the transparent polymeric material.

While at least one embodiment has been presented in the foregoing detailed description, it should be appreciated that a vast number of variations exist. It should also be appreciated that the embodiment or embodiments are only examples, and are not intended to limit the scope, applicability, or configuration in any way. Rather, the foregoing detailed description will provide those skilled in the art with a convenient road map for implementing an embodiment described herein. It being understood that various changes may be made in the function and arrangement of elements described in an embodiment without departing from the scope of the detailed description as set forth in the appended claims.

### EXAMPLES

Examples herein provide anti-fog coatings having increased abrasion resistance and mitigate surfactant diffusion.

Example 1 includes subject matter directed toward an anti-fog coating, comprising: a cationically polymerizable compound including at least one epoxy group; a radically polymerizable compound including at least one acrylate group; a non-ionic surfactant; and an ionic surfactant.

In Example 2, the subject matter of Example 1 can be optionally configured such that wherein the non-ionic surfactant comprises one or more reactive groups that can be chemically bonded to a polymer matrix by a curing process, and wherein the polymer matrix is formed of cationically and radically polymerizable compounds.

In Example 3, the subject matter of Examples 1 or 2 can be optionally configured such that wherein the one or more reactive groups comprises vinyl, hydroxyl, carboxyl, acrylic, epoxy, urethane, amine, and wherein the curing process includes, UV, thermal, moisture, or chemical crosslinking.

In Example 4, the subject matter of Examples 1-3 can be optionally configured such that wherein the anti-fog coating is configured to be washed such that at least a portion of the ionic surfactant is removed from the anti-fog coating.

In Example 5, the subject matter of Examples 1-4 can be optionally configured such that wherein the ionic surfactant is dioctyl sulfosuccinate sodium

In Example 6, the subject matter of Examples 1-5 can be optionally configured such that wherein the non-ionic surfactant is about 0.1 wt % to about 10 wt % of the anti-fog coating.

In Example 7, the subject matter of Examples 1-6 can be optionally configured such that wherein the ionic surfactant is about 0.1 wt % to about 10 wt % of the anti-fog coating.

In Example 8, the subject matter of Examples 1-7 can be optionally configured to further comprise a cationic polymerization initiator that causes polymerization of the cationically polymerizable compound upon exposure to ultraviolet radiation, thermal energy, or actinic radiation.

Example 9, the subject matter of Examples 1-8 can be optionally configured to further comprise a free radical polymerization initiator that causes polymerization of the radically polymerizable compound upon exposure to ultraviolet radiation, thermal energy, or actinic radiation.

In Example 10 includes subject matter including a method for forming an anti-fog coated surface, comprising: preparing an anti-fog coating, the anti-fog coating comprising: a cationically polymerizable compound including at least one epoxy group; a radically polymerizable compound including at least one acrylate group; a non-ionic surfactant; and an ionic surfactant; applying the anti-fog coating to a surface; curing the anti-fog coating to form an anti-fog coated surface; contacting the anti-fog coated surface with water; and drying the anti-fog coated surface.

In Example 11, the subject matter of Examples 1-10 can be optionally configured such that wherein the preparing includes combining a cationic polymerization initiator and a free radical polymerization initiator with the cationically polymerizable compound, the radically polymerizable compound, wherein the curing includes: exposing the cationic polymerization initiator to ultraviolet radiation, thermal energy, or actinic to cause polymerization of the cationically polymerizable compound; and exposing the free radical polymerization initiator to the ultraviolet radiation, the thermal energy, or the actinic radiation to cause polymerization of the radically polymerizable compound.

In Example 12, the subject matter of Examples 1-11 can be optionally configured such that wherein the contacting includes soaking the anti-fog coated surface in water from about 1 second to about 1 minute.

In Example 13, the subject matter of Examples 1-12 can be optionally configured such that wherein the contacting includes misting the anti-fog surface with water.

In Example 14, the subject matter of Examples 1-13 can be optionally configured such that wherein the drying includes air drying the anti-fog coated surface.

In Example 15, the subject matter of Examples 1-14 can be optionally configured such that wherein the preparing includes providing an ionic surfactant to non-ionic surfactant weight ratio of about 1:1 to about 1:30.

1. An anti-fog coating, comprising:
a cationically polymerizable compound including at least one epoxy group;
a radically polymerizable compound including at least one acrylate group;
a non-ionic surfactant; and
an ionic surfactant.

2. The anti-fog coating of claim 1, wherein the non-ionic surfactant comprises one or more reactive groups that can be chemically bonded to a polymer matrix by a curing process, and wherein the polymer matrix is formed of cationically and radically polymerizable compounds.

3. The anti-fog coating of claim 2, wherein the one or more reactive groups comprises vinyl, hydroxyl, carboxyl, acrylic, epoxy, urethane, amine, and wherein the curing process includes, UV, thermal, moisture, or chemical crosslinking.

4. The anti-fog coating of claim 1, wherein the anti-fog coating is configured to be washed such that at least a portion of the ionic surfactant is removed from the anti-fog coating.

5. The anti-fog coating of claim 1, wherein the ionic surfactant is dioctyl sulfosuccinate sodium.

6. The anti-fog coating of claim 1, wherein the non-ionic surfactant is about 0.1 wt % to about 10 wt % of the anti-fog coating.

7. The anti-fog coating of claim 1, wherein the ionic surfactant is about 0.1 wt % to about 10 wt % of the anti-fog coating.

8. The anti-fog coating of claim 1, further comprising a cationic polymerization initiator that causes polymerization of the cationically polymerizable compound upon exposure to ultraviolet radiation, thermal energy, or actinic radiation.

9. The anti-fog coating of claim 1, further comprising a free radical polymerization initiator that causes polymerization of the radically polymerizable compound upon exposure to ultraviolet radiation, thermal energy, or actinic radiation.

10. A method for forming an anti-fog coated surface, comprising:
preparing an anti-fog coating, the anti-fog coating comprising:
a cationically polymerizable compound including at least one epoxy group;
a radically polymerizable compound including at least one acrylate group;
a non-ionic surfactant; and
an ionic surfactant;
applying the anti-fog coating to a surface;
curing the anti-fog coating to form an anti-fog coated surface;
contacting the anti-fog coated surface with water; and
drying the anti-fog coated surface.

11. The method of claim 10, wherein the preparing includes combining a cationic polymerization initiator and a free radical polymerization initiator with the cationically polymerizable compound, the radically polymerizable compound, wherein the curing includes:
exposing the cationic polymerization initiator to ultraviolet radiation, thermal energy, or actinic to cause polymerization of the cationically polymerizable compound; and
exposing the free radical polymerization initiator to the ultraviolet radiation, the thermal energy, or the actinic radiation to cause polymerization of the radically polymerizable compound.

12. The method of claim 10, wherein the contacting includes soaking the anti-fog coated surface in water from about 1 second to about 1 minute.

13. The method of claim 10, wherein the contacting includes misting the anti-fog surface with water.

14. The method of claim 10, wherein the drying includes air drying the anti-fog coated surface.

15. The method of claim 10, wherein the preparing includes providing an ionic surfactant to non-ionic surfactant weight ratio of about 1:1 to about 1:30.
